(19) United States
(12) Patent Application Publication
(10) Pub. No.: US 2009/0291315 A1
(43) Pub. Date: Nov. 26, 2009

(54) Ultra Violet Resistant Coating for Wood Products

(76) Inventors: Darryl J. Costin, Westlake, OH (US); Darryl Costin, JR., Avon, OH (US)

Correspondence Address: Law Office of Scott C Harris Inc, PO Box 1389, Rancho Santa Fe, CA, 92067, US

(21) Appl. No.: 12/354,774

(22) Filed: Jan. 16, 2009

Related U.S. Application Data
(60) Provisional application No. 61/023,124, filed on Jan. 24, 2008.
(60) Provisional application No. 61/054,329, filed on May 19, 2008.

(51) Int. Cl. B32B 21/04; F21V 9/06

(52) U.S. Cl. 428/537.1; 252/588; 252/589

(57) ABSTRACT

A coating used on wood products that absorbs ultraviolet (UV) light to prevent damage from the UV, and also is mixed with a UV stabilizer. By preventing UV light from shining through to the wood, wood damage from sunlight is minimized.

This application claims priority from provisional application No. 61/023,124, filed Jan. 24, 2008, and provisional application No. 61/054,329, filed May 18, 2008, the entire contents of both of said applications are herewith incorporated by reference.

### BACKGROUND

Outdoor wood and wood fiber products are significantly degraded by ultraviolet light. Various techniques have been used to combat this degradation.

Such wood products find wide scale application for exterior building components including windows, doors, decking, home exteriors and a variety of outside furniture and children play sets.

No wood type or species is immune to the damaging effects of the weather when used in outdoor applications such as wood decking. Water absorption, decay, dimensional change and fading or surface graying are well known problems associated with wood substrates subject to the harmful effects of the weather—rain, snow and ultra violet (UV) radiation. Therefore these products must be protected from the damaging effects of the weather. The typical manner in which wood substrates are protected from the harmful effects of outdoor exposure is through three conventional treatments.

A first is to pressure-treat the wood. Pressure treatment is a process that forces chemical preservatives into the wood. Typically, wood is placed under vacuum and pressure inside a closed cylinder to force the preservatives into the wood. The preservatives help protect the wood from attack by termites, other insects, and fungal decay. For example, Wolmanized Natural Select™ is a trade name of a common wood preservative treatment which uses a copper azole to protect the wood from rot and decay. Disadvantages of pressure treated wood include preservative chemical residue that may cause health problems and if left untreated and pressure treated wood can turn a muddy gray discolor with continued exposure to the sun. It also shrinks significantly unless kiln dried properly after treatment and new preservatives require more care in fastening and joints to reduce cupping and warping. Pressure treated Southern yellow pine checks and splinters as it dries as well.

A second treatment is the application of water repellent or water sealer coatings. These coatings prevent water and moisture absorption, so that structural damage like cracking and warping are minimized. An example of this type of product is the water based Raincoat® products from Wolman®. Although this type of product provides some UV protection, the coating does not stop the frequent maintenance required of wood decks because of the fading of the wood.

A third treatment is the application of stains or other finishes. These coatings contain pigment to provide color and some protection against UV damage. An example of this type of product is the oil based F & P® products from Wolman®. Similar products come with varying degrees of transparency, which gives you a range of options for highlighting the wood grain, or covering it completely. Such stains and finishes are commonly available from a number of manufacturers. However, once again, these products obviously were not invented to provide maximum UV protection since stained wood decks still require maintenance every year or so to prevent the fading of the wood.

One commercial product, SealRx, promotes that the coating is different in that it provides a dynamic seal which is continuously activated by moisture to re-seal every time it gets wet. The coating is actually warranted for 25 years and claims to penetrate the surface and bond internally to provide the permanent seal. Seal Rx is reported to inhibit growth of mildew, mold and algae growth. Yet the product literature indicates that indeed a deck coated with SealRx will turn gray from exposure to the sun and thus may present an appearance that is cosmetically unacceptable. The authors found a host of products from a variety of manufacturers, all claiming to reduce the damage from UV exposure. Some of the claims taken from the web include: “provides a mildew and UV resistant coating”, “specially formulated to guard exterior wood from its two biggest enemies—water and sun”, “one-coat maximum strength protection with a coating that resists UV damage, allowing your wood to maintain its natural color” and “SunBlock UV protection”

Yet, it appeared that every single one of these products when applied to wood decks still required frequent maintenance due to the graying of the wood caused by the exposure to the sun and weather and particularly the harmful effects of UV.

### SUMMARY

The authors found it interesting that no common treatment to wood products exposed to the outdoors involves the application of a special coating first and foremost to provide maximum resistance to the harmful UV radiation from the sun. Yet one of the major complaints of people with wood decks is the continuing fading which requires frequent maintenance. The fading or graying is the result of the wood fiber degradation on the surface caused by the UV exposure. The gray color will eventually degrade to a much darker color if the product is not treated. Wood decks present a particularly severe exposure for both the wood and the various stains, sealers and finishes. Most wood sections are in a horizontal or flat position. These horizontal surfaces are generally exposed to the direct potent rays of the sun so the weathering process is greatly accelerated.

An embodiment discloses a new way of protecting wood from UV.

### BRIEF DESCRIPTION OF THE DRAWINGS

FIG. 1 is an illustrative drawing showing the penetration of Ultra violet light through a coating.

FIG. 2 is a graph of the Electromagnetic Spectrum for the Wolman® F & P® coating.

FIG. 3 is a graph of the Electromagnetic Spectrum for a special UV Resistant coating developed by the authors.

### DETAILED DESCRIPTION

Wood degrades when exposed to sunlight. Cedar and redwood substrates often contain natural preservatives. However studies show redwood rots when exposed for sustained periods to moisture. Cedar breaks down very quickly in moist conditions. UV rays are by far cedar's biggest enemy, breaking down the lignin (a component of wood cells) thus leading to discoloration and destruction. Cedar is world renowned for its stunning appearance, rich grain and gorgeous coloring that adds great value to any exterior of a property. Therefore some type of UV protection extends the life of these products used outdoors.

There is a growing interest in heat treating wood to achieve the resistance to decay and pesticides common to pressure treated wood. However, the heat treated wood has no effective UV resistance and fades considerably. It would be a major breakthrough if a coating could be developed for heat treated wood to improve UV resistance and therefore delay fading of the wood.

Wood composite decking has become increasingly popular in recent years due to the fact that it is virtually indestructible, splinter-free, easy to install and reported to be of low maintenance. However, due to damage from UV radiation, the color and appearance of the wood composite fades over time. The fading is not as dramatic as with wood. However, unlike wood decks, when the color fades on wood composite decking, the result is not reversible and nothing can be done except replace the product completely.

Despite the growing use of wood composites and all-plastic or metal decking, most new residential decks are still made from wood. Pressure-treated lumber and naturally decay-resistant species such as cedar and redwood are not immune from the effects of weather and specifically the effects of UV radiation. Thus, most homeowners and deck professionals will turn to a deck finish to slow the aging process and prolong the life of their decking. A most popular choice of decking material in the US is pressure treated Southern yellow pine. A variety of water repellents and stains are used to protect the surface from degradation from water and the sun. However, in order to minimize the color fading of the deck from its initial greenish color to gray, the deck must be treated with these coatings frequently, often every year or so. It would certainly be a significant impact on the industry and the homeowners if an improved UV resistant coating could be developed that would prevent or delay the fading of the wood for several years. Such a novel coating used on heat treated wood will have an enormous favorable impact on the environmental or green movement by reducing, if not eliminating, the chemical pressure treated process.

Virtually all the development for protective coatings for outdoor wood products such as wood decking is concentrated on preservatives, sealers and stains. These coatings protect the wood decking from water, termites, and other decay and provide color, but offer only marginal UV protection. Even if a customer applies highly regarded commercial sealers made by Thompson or Wolman®, to the wood decks, the initial greenish color of the pressure treated wood decking fades to grey in less than a year or so. The authors believe, in contrast to the conventional teaching on this subject, that new coatings other than the conventional preservative, stain and sealer type coatings discussed, and which are based upon optical theory, could provide maximum protection of the wood substrate from the harmful UV radiation.

An embodiment discloses a new family of coatings on wood and wood composite substrates to protect the products from outdoor exposure to the harmful UV radiation.

The authors believe that a critical major problem with outdoor exposure to wood decking is the effect of UV on the fading of the wood. Therefore, the authors have searched for solutions to, first and foremost, provide maximum UV protection to the wood substrate. The authors believed that if maximum UV protection could be sought first, then it could be uniquely found that the coating may provide protection against the other weathering elements. Another advantage is that maximum UV protection would extend the life of the decking material to several years before it turns gray.

A UV resistant coating applied to heat treated lumber could reduce the chemical pressure treated process and have a significant impact on the environment. This of course, would be a major breakthrough in the wood industry. This coating can also be used in the first embodiment to coat a wood composite substrate.

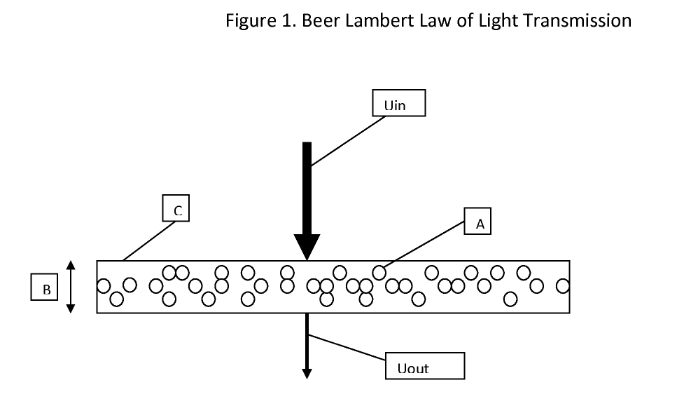

This embodiment describes a coating for wood substrates that offers maximum protection to UV radiation. In order to develop a coating which offers maximum protection to UV radiation, attention is paid to Beer Lambert's Law of light transmission. The law is simply illustrated for the case of UV light transmission in FIG. 1. FIG. 1 shows that a beam of monochromatic radiation with power Uᵢₙ of say UV light directed at a coating C with a thickness B, leaves the coating at a power level of Uₒᵤₜ. The difference between the power level Uᵢₙ and Uₒᵤₜ is due to A, the particles in the coating that absorb the specific wavelengths of UV radiation and the thickness of the coating B. The absorbance of UV radiation is thus a function of the concentration of particles A and the thickness of the coating B.

In addition to Beer Lambert's Law, it is known that some compounds can stabilize or reflect UV radiation and thus further improvement can be used with the addition of these compounds. A purpose of the UV light stabilizer of an embodiment is to eliminate the creation of free radicals which decrease the UV absorption capacity and result in discolorations of the coating. Further, UV stabilizers can have a synergistic effect on reducing UV when coupled with UV absorbers.

A good way to develop a maximum UV resistant coating for wood is given in the authors' invention below:

Use a host material which in itself has UV resistance properties. Example host materials may include acrylic or polyurethane or other host material which is generally considered to exhibit good UV resistance it and by itself.

Second use at least one compound which is known to absorb the wavelengths of light common to UV radiation, namely from about 200-400 nanometers. Examples include titanium dioxide, benzotriazole, benzophenone, arylester, oxanilide, zinc oxide, octyl methoxycinnamate and 4-aminobenzoic acid.

Determine the solubility limits of the UV absorber in the host material so as to provide a coating with maximum UV absorber concentration up to the solubility limit, e.g., more than 90% of the solubility limit of the host.

Add UV light stabilizers, such as a hindered amine.

Apply the coating to the greatest thickness that is practical. This may require for example the application of one very thick coating or multiple applications of a coating. The intent of this system is to form a product that is not absorbed, and the product preferably does not have any additives that facilitate the product penetrating into the substrate (e.g., the wood).

These 5 items together may produce the best results; however, some of these steps may be removed in at least one embodiment. Accordingly, the authors hired an outside laboratory to make up some polymers with varying degrees of UV absorbers and stabilizers and tested the coatings on a variety of wood substrates such as pressure treated wood (which is commonly used for wood decking) and heat treated wood (which has been developed to reduce the environmental issues associated with the chemical treatment process for pressure treated wood) and wood composites. These custom polymer coatings were applied to the wood substrates and tested in the Xenon weatherometer according to ASTM standard G-155 for 250 hours. In addition, as controls, the same wood substrates were coated with the leading deck coatings in the marketplace, Wolman's® Raincoat® water repellent coating for wood decks and Wolman's® F & P® premium wood finish and preservative product for wood decks. The Wolman's® website answers the question of which of the Wolman's® products will prevent wood from turning gray? The answer posted on the web site is:

“Raincoat® with Toner utilizes UV blockers to help delay the wood's natural tendency to turn gray from exposure to the sun's ultraviolet rays and Wolman's® F & P® 's transparent pigments absorb and reflect UV rays to resist premature fading and wood graying, while allowing the wood grain and texture to show through.”

Consequently, the authors tested both Wolman® coatings on the wood substrates as controls.

Further, the authors tested the Sherwin Williams Sher-Clear 1K coating which has been approved for Trex wood composite decking. This product was advertised as a high gloss UV resistant acrylic clear coat.

The main differences between the Wolman® coatings and the authors' novel experimental coatings were that: 1). the Wolman® coatings penetrated into the wood and our custom polymer coating only served as a coating on top of the wood without any significant penetration into the wood and 2). Our coating was based on a UV resistance polymer with a high concentration of UV absorbers and stabilizers. The results from these trials were quite surprising in every case as shown in Tables I to III below:

TABLE I
Results of Xenon Arc Weatherometer
Tests for Pressure Treated Lumber

| Material | Coating | Result |
|---|---|---|
| Pressure Treated | None | Severe Discoloration & Fading |
| Lumber | | |
| Pressure Treated | Wolman ® | Severe Discoloration & Fading |
| Lumber | F & P ® | |
| Pressure Treated | Authors' New | Minimal if any Fading |
| Lumber | UV Resistant | |
| | Coating | |

TABLE II
Results of Xenon Arc Weatherometer Tests for Super Heated Popular

| Material | Coating | Result |
|---|---|---|
| Super Heated Popular | None | Severe Discoloration & Fading |
| Super Heated Popular | Wolman ® | Severe Discoloration & Fading |
| | Raincoat ® | |
| Super Heated Popular | Authors' New | Minimal if any Fading |
| | UV Resistant | |
| | Coating | |

TABLE III
Results of Xenon Arc Weatherometer Tests for Trex Wood Composite

| Material | Coating | Result |
|---|---|---|
| Trex Wood Composite | None | Severe Discoloration & Fading |
| Trex Wood Composite | Sherwin | Severe Discoloration & Fading |
| | Williams Sher- | |
| | Clear 1K | |
| Trex Wood Composite | Authors' New | Minimal if any Fading |
| | UV Resistant | |
| | Coating | |

The results can be clearly summarized as follows:

1. The Wolman® commercial coatings applied to various wood decking products ALL resulted in significant to severe Fading of the decking product after only 250 hour weatherometer exposure.

2. The Sherwin Williams Sher-Clear 1K coating applied to Trex wood composite decking resulted in significant to severe Fading of the decking product after only 250 hour weatherometer exposure.

3. The authors' novel UV resistant coatings developed from optical theory applied to the same substrates did not fade or resulted in very minimal fading after the identical weatherometer exposure.

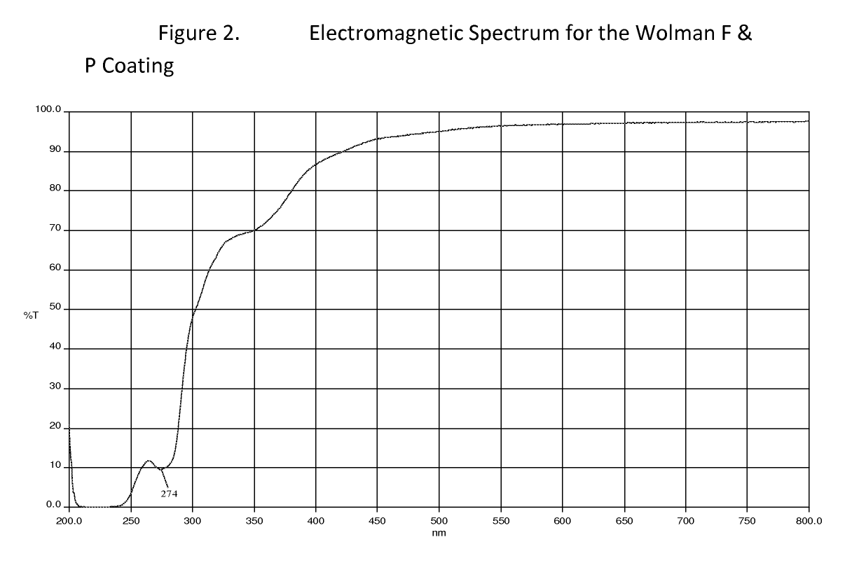

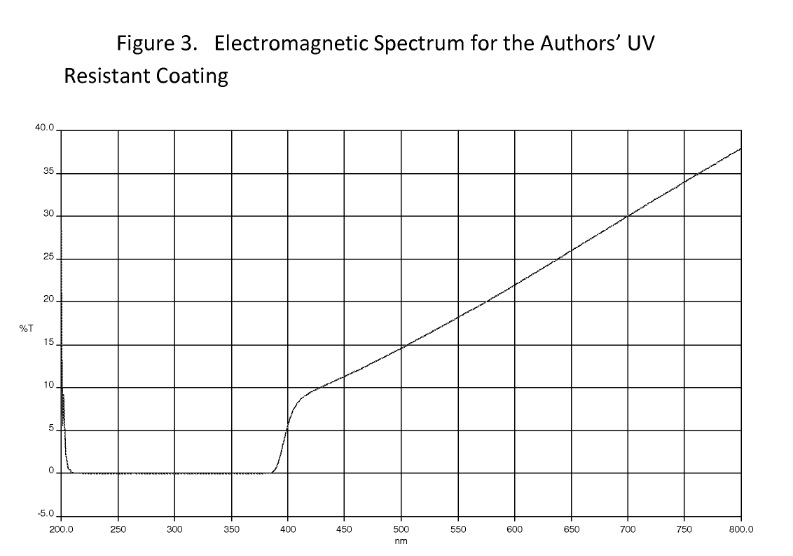

To further test the authors' novel concepts a spectrum of pure polyethylene was acquired against an air reference, while the UV-visible spectra of the Wolman® F & P® coating and the authors' novel coating were acquired against the polyethylene as the reference. The results from this spectral test are displayed in FIGS. 2-3 and are extremely informative. FIG. 2 shows Electromagnetic Spectrum for the Wolman® F & P® Coating. The figure shows that the UV transmission through the Wolman® F & P® coating ranges from 48% at 300 nm to 87% at 400 nm. FIG. 3 shows Electromagnetic Spectrum for one of authors' novel UV resistant coatings tested. The figure shows that the UV transmission through the authors' novel UV resistant coating ranges from 0% at 300 nm to 6% at 400 nm. Table IV below summarizes these findings. The table very clearly explains the unusual results found from the weatherometer tests and shown in Tables I-III above. The authors' novel UV resistant coating resulted in zero to minimal fading because the UV transmission was essentially blocked from entering the wood substrate.

TABLE IV
Summary of Electromagnetic Spectrum Results

| | UV Transmission % | UV Transmission % |
|---|---|---|
| Coating | @ 300 nm | @ 400 nm |
| Wolman ®F & P ® | 48 | 87 |
| Authors' New UV | 0 | 6 |
| Resistant Coating | | |

This is contrary to commercial coatings in which UV readily penetrates through the coating into the wood substrate due in part to the thinness and penetrating capabilities of the commercial coating. This common property, in and by itself, does not permit maximum reduction of UV according to the teachings of the Beer Lambert law.

All commercial wood coatings emphasize the importance of coatings which penetrate the wood to seal it and/or repel the water from seeping into the wood. Furthermore, one point is best illustrated on Thompson's® web page for the application of one of the leading wood deck protective coatings, Thompson's® water sealer. The web page hosts a video for the application of this product on wood decks and clearly illustrates that one thin application is all that is necessary. Wolman's® Raincoat® water repellent coating for wood decks offers a 3 year performance guarantee. Yet the application instructions call for only one coat. Similarly Wolman's® F & P® premium wood finish and preservative product for wood decks indicates on the container that the product resists color fading and wood graying. Yet the application instructions for wood decks call for only one coat. Thus, maximum UV protection cannot be expected from these commercial coatings due to the thinness of the coating.

The teaching and expectation in the art is that thin coatings should be used which penetrate the wood. The industry standard is that thick coatings which form a film on the wood are to be avoided.

The present application goes against this established teaching to provide coatings with maximum UV protection. The present application teaches that films with maximum UV absorbers and maximum practical thicknesses indeed should be used. This goes against the established teaching in the art.

Those skilled in the art know that there are a host of compounds that could be used as additives to provide UV absorption, UV stabilization, UV reflection and/or UV filtering to the host material for the specific development of a maximum UV resistance coating for wood and wood composite substrates. For example the use of nanosized inorganic materials is known to offer excellent UV absorption properties. The specialty chemicals used in sun screens is another embodiment.

According to an embodiment, the amount of UV radiation absorbed in a coating is a function of both coating thickness and absorber concentration. So in order to achieve maximum UV protection, the amount of the UV absorbers must be increased to some maximum limit and the thickness of the coating must be maximized to some practical limit. Thus, first the solubility limits of these additives in the host can be determined, such that the amounts of the additives can be increased up to the solubility limits. Hence, the maximum possible UV resistance can be obtained in the coating from each additive and from the combined or synergistic effects of the other additives. Further, since the amount of UV absorption is generally dependent upon the thickness of the coating, this embodiment discloses to increase the coating on the wood to maximum practical limits. This could require multiple applications or layers of the coating on the deck. Most coating systems generally suggest that one application of the sealer, preservative or stain is only required. However, in this invention, it is disclosed that in order to obtain a maximum UV resistant coating, multiple layers or a very thick first application is required. However, it is believed that a homeowner would be happy to apply multiple coatings to their wood deck if it were truly a one-time application. The whole reason why the wood composite decking business has grown to a multi billion dollar industry even at substantially higher prices than wood decking is from the promise that the wood composite deck will require no maintenance. There simply is no such coating in existence today that provides maximum UV protection for wood products used in exterior applications. In fact, such a coating could even find useful application in interior wood products exposed to the sun, such as flooring.

Another embodiment may use a special application system in which a layer of the coating is applied to the wood substrate using an application bar or brush or dipping process. A drying/curing process is carried out on the applied part using air, infra red and/or uv curing. A small area is applied, and then dried and cured. Then another layer may be applied and cured. In this way, the multiple layers are in essence applied in a single process. This particular embodiment would be a means to apply the novel UV resistance coating at the pressure treated lumber mill, for example. In that way, a super premium wood decking product could be provided to the end user where the product has the aesthetic appeal of real wood but with a special UV resistant coating already applied to the wood such that little or no maintenance would be required as the wood deck is exposed to the UV from the sun.

Another embodiment may make the application device robotic, in which it moves across the deck to apply the material, and then moves back across the deck to apply a second layer.

Once the maximum UV resistant properties are achieved, other chemical additives can be used to achieve improved properties. Those skilled in the art know that several different chemical additives can be used to achieve improved adhesion, water resistance, slip resistance, fire resistance, decay resistance, different levels of gloss, different colors, etc. Finally, other coatings can be used in concert with the maximum UV resistance coating disclosed in this invention. Such coatings may provide additional protection against decay, dimensional stability, water resistance and provide aesthetic options.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A coating for a wood or wood composite product, comprising:
a host material which has ultraviolet resistance properties;
a wavelength absorbing compound, mixed with said host materials, which absorbs at least some wavelength of ultraviolet light; and
an ultraviolet light stabilizer, mixed with said host material and some wavelength absorbing material.

2. A coating as in claim 1, wherein said ultraviolet absorber is provided at a concentration at substantially as solubility limit of the host.

3. A coating as in claim 1, wherein the thickness of the coating is maximized to practical limits.

4. A coating as in claim 1 wherein two layers of the coating are applied to the wood or wood composite product.

5. A coating as in claim 1, which does not include penetrating improving products, which facilitate the penetrating of the product into the substrate.

6. A coating for wood or wood composite products containing a UV resistant host polymer, UV absorbers and UV stabilizers which result in a UV transmission through the coating less than 30% at 400 nm.

7. A coating for wood or wood composite products containing a UV resistant host polymer, UV absorbers and UV stabilizers which result in a UV transmission less than 20% at 400 nm through the coating.

8. A coating for wood or wood composite products containing a UV resistant host polymer, UV absorbers and UV stabilizers which result in a UV transmission less than 10% at 400 nm through the coating.

9. A coating as in claim 1 which is applied at the lumber or extrusion mill which manufactures pressure treated lumber, heat treated lumber, wood composite lumber or exterior wood products.

10. A premium exterior wood product which is provided to the customer with a UV resistant coating already applied which has a UV transmission less than 30% at 400 nm through the coating.

11. A premium exterior wood product which is provided to the customer with a UV resistant coating already applied which has a UV transmission less than 10% at 400 nm through the coating.

12. A UV resistant coating when applied to exterior wood products which results in less than 30% fading of the wood product after two years exposure.

13. A coating for an exterior wood product, comprising:
a material which has ultraviolet resistance properties, and formed without more than 20% penetration of the coating into the wood product.

14. A coating for a substrate including metal and plastic and other composite substrates, comprising:
a host material which has ultraviolet resistance properties;
a wavelength absorbing compound, mixed with said host materials, which absorbs at least some wavelength of ultraviolet light; and
an ultraviolet light stabilizer, mixed with said host material and some wavelength absorbing material.
